(19) United States
(12) Patent Application Publication
(10) Pub. No.: US 2011/0086152 A1
(43) Pub. Date: Apr. 14, 2011

(54) Glycine-bearing leavening system for the production of bakery products

(75) Inventors: Gideon Rath, Darmstadt (DE); Rainer Schnee, Mainz (DE)

(73) Assignee: Chemische Fabrik Budenheim KG, Budenheim (DE)

(21) Appl. No.: 12/658,312

(22) Filed: Feb. 10, 2010

(30) Foreign Application Priority Data
Oct. 9, 2009 (DE) DE102009045534.5

(51) Int. Cl. A21D 2/24; A21D 2/08

(52) U.S. Cl. 426/551; 426/561; 426/562; 426/653

(57) ABSTRACT

A leavening system, in particular for the production of bakery products, which as a raising acid contains glycine alone (100%) or in combination with at least one further raising acid different from glycine.

### CROSS REFERENCE TO RELATED APPLICATIONS

This application claims priority from German Patent Application DE 10 2009 045 534.5 filed Oct. 9, 2009.

### BACKGROUND OF THE INVENTION

The invention concerns a raising (leavening) system, in particular for the production of bakery products, a novel raising acid combination for such a leavening system and the use of the leavening system.

The use of leavening systems for the production of bakery products, in particular for loosening the dough or mixture, is a common practice. Suitable dough additives and methods provide that during the production of the bakery products gas, generally carbon dioxide gas, is liberated, which causes the dough to rise and thus loosens it. Fermentatively acting leavening systems such as yeast or sour dough, thermally induced gas carriers or chemical leavening systems can be used for that purpose. In the case of the chemical bakery leavening systems a carbon dioxide carrier reacts with an acid carrier (raising acid), with liberation of carbon dioxide (CO₂).

Sodium hydrogen carbonate (NaHCO₃) is very frequently used as the carbon dioxide carrier, but other carbon dioxide carriers are also employed such as potassium carbonate (potash), ammonium hydrogen carbonate (ABC raising agent) and baker's salt, a mixture of ammonium compounds of carbonic and carbamic acid, sodium carbonate, magnesium carbonate, magnesium hydrogen carbonate, calcium carbonate, calcium hydrogen carbonate, aluminium carbonate, aluminium hydrogen carbonate, iron carbonate, iron hydrogen carbonate, ammonium carbonate or ammonium carbamate.

Various acids and acid salts are known as acid carriers (raising acids). A list of the most important raising acids is to be found for example in the ‘Richtlinie für Backtriebmittel, Backpulver, Hirschhornsalz and Pottasche’ [Guidelines for Bakery Leavening Agents, Baking Powder, Baker's Salt and Potash] (BLL 1962) and in the literature at Brose et al ‘Chemische Backtriebmittel’; 2nd edition, 2007.

Acid salts of pyrophosphoric acid are frequently used as raising acids such as acid sodium pyrophosphate (SAPP). They however have the disadvantage that they involve a typical, frequently undesired particular taste (pyrophosphate taste). Further examples of phosphate-bearing and phosphate-free raising acids are monocalcium phosphate monohydrate (MCPM), anhydrous monocalcium phosphate (AMCP), dicalcium phosphate dihydrate (DCPD), acid sodium aluminium phosphate (SALP), sodium aluminium sulphate (SAS), tartar (acid potassium tartrate), gluconic acid delta lactone (GDL), citric acid, tartaric acid, fumaric acid and lactic acid.

Two particularly important factors for characterising raising acids are the neutralisation value (NV) and the rate of reaction (ROR).

The neutralisation value specifies how much acid carrier is required to neutralise a given carbon dioxide carrier. It is obtained by dividing the amount of carbon dioxide carrier by the amount of acid carrier which is used for neutralisation of the carbon dioxide carrier, and multiplying the resulting quotient by 100.

The ROR is the percentage of the amount of carbon dioxide gas (mol) which actually occurs, in comparison with the amount of carbon dioxide gas that can be theoretically obtained upon complete reaction, in the reaction of a stoichiometric ratio of carbon dioxide carrier and acid carrier at a temperature of 21° C. for a period of 8 minutes.

Leavening systems for the production of bakery products are frequently of such a composition that upon storage prior to use at ambient temperature, as far as possible they still do not undergo complete reaction, with the formation of carbon dioxide gas. The liberation of carbon dioxide gas should preferably only occur at elevated temperature, generally at the baking temperature. Besides the choice of carbon dioxide carrier or carriers and acid carrier or carriers, the properties and the reactivity of the leavening system can also be influenced by additives such as for example separating agent for preventing or delaying the premature reaction between the carbon dioxide carrier and the acid carrier. Suitable substances for that purposes are for example grain starch such as maize starch, rice starch or wheat starch, modified meal flour, silicon dioxide such as pyrogenic silicic acid, hydrophobic silicic acid or hydrophilic silicic acid, tricalcium phosphates, calcium carbonate, calcium sulphate, silanes, fats and mixtures of the aforementioned substances.

The raising acids are frequently used individually in the leavening systems. They can however also be used as mixtures, so-called ‘double acting baking powder’, in which case the selection of raising acids with different rates of reaction (ROR) makes it possible to influence the foaming properties in order for example to achieve particularly homogeneous pore formation. It is assumed that the combination of a slow-reacting and a fast-reacting acid carrier initially provides for the formation of a multiplicity of small foam bubbles by virtue of the acid carrier which reacts more quickly, at a relatively high speed, the foam bubbles then being filled up in the reaction with the more slowly reacting acid carrier at relatively low speed. In that case highly uniform foaming and pore formation are observed.

Many raising acids suffer from the disadvantage that they already react very quickly with the carbon dioxide carrier in the preparation of dough, when water is added, and then there is no longer any carbon dioxide available for the leavening action during dough development or during baking. That is a problem in particular for bakery products involving a prolonged baking time. For that reason pyrophosphate, in particular acid sodium pyrophosphate (SAPP) is frequently used as it reacts with a delay. That however can adversely affect the baking result by virtue of its above-mentioned particular taste (pyrophosphate taste) which can be caused in particular when large amounts are involved.

In addition viewed in the long term the mineral phosphate resources are finite. It would therefore be desirable to have phosphate-reduced leavening systems in order to be able to cut down on the consumption of phosphate.

The problem of the invention was that of providing a leavening system, in particular a leavening system for the production of bakery products, which has a lower phosphate content in comparison with phosphate-based leavening systems and which nonetheless achieves good loosening and pore formation with advantageous reaction rates and which when used for the production of bakery products does not cause any adverse effect on taste in the bakery products, caused by the raising acid.

### BRIEF SUMMARY OF THE INVENTION

The above problem, of providing a leavening system, in particular a leavening system for the production of bakery products, which has a lower phosphate content in comparison with phosphate-based leavening systems and which nonetheless achieves good loosening and pore formation with advantageous reaction rates and which when used for the production of bakery products does not cause any adverse effect on taste in the bakery products, caused by the raising acid, is solved by a leavening system, in particular for the production of bakery products, which as raising acid contains glycine alone (100%) or in combination with at least one further raising acid different from glycine.

The use of glycine as a raising acid, in particular as a raising acid for the production of bakery products, was hitherto not usual and is also not described in the literature. A reason for that is thought to be the price of that amino acid, which is relatively high in relation to known raising acids.

It was now surprisingly found that the use of glycine alone (100%) as a raising acid or in combination with at least one further raising acid different from glycine increases the raising efficiency of the leavening system in relation to conventionally employed raising acids and affords a greater loosening effect.

In particular the invention is a leavening system for the production of bakery products having a raising acid and at least one gas carrier that reacts with the raising acid or acids with the liberation of gas, wherein as raising acid it contains glycine alone (100%) or in combination with at least one further raising acid different from glycine.

### DETAILED DESCRIPTION OF THE INVENTION

The combination according to the invention of glycine with at least one further raising acid different from glycine not only makes it possible to achieve a good leavening effect but, in the production of bakery products, it also makes it possible to reduce or entirely eliminate an unwanted deviation from the bakery-typical taste, while preventing excessive darkening or a burnt appearance.

According to the invention a leavening system which contains glycine in combination with at least one further raising acid different from glycine is particularly preferred for the production of bakery products, in accordance with the invention. Many known raising acids are suitable for that purpose, but preferably the at least one further raising acid different from glycine includes acid sodium pyrophosphate (SAPP), citric acid, fumaric acid, asparagine, tartaric acid, tartar (potassium hydrogen tartrate), glucono-delta lactone, sodium hydrogen citrate, lactic acid or mixtures or combinations of the aforementioned substances. Fumaric acid, citric acid, acid sodium pyrophosphate (SAPP) or a mixture or combination of fumaric acid, citric acid and/or acid sodium pyrophosphate (SAPP) are quite particularly preferred.

In an embodiment of the leavening system according to the invention the raising acid combination of glycine with at least one further raising acid different from glycine contains from 5 to 95% by weight of glycine or 10 to 90% by weight of glycine or 20 to 80% by weight of glycine or 30 to 70% by weight of glycine and as the balance the further raising acid or acids different from glycine.

Less than 5% by weight of glycine should not be contained in the raising acid combination as otherwise the advantageous effect of glycine on the raising efficiency cannot be deployed to an adequate degree. Advantageously not less than 10% by weight of glycine is used. Higher proportions of glycine, in combination with fast-reacting raising acids, provide for particularly good loosening of the dough or mixture.

A raising acid combination according to the invention comprising glycine and SAPP as at least one further raising acid exhibited a raising action which is comparably good to the SAPP which is frequently used alone. With a mixture ratio of 50% by weight respectively the raising efficiency of the combination was higher than that of the individual acids. The raising acid combination with glycine made it possible to reduce or entirely eliminate the typical pyrophosphate taste caused by SAPP alone. In addition the combination provides that the phosphate content overall is advantageously considerably reduced in comparison with the SAPP which is frequently used alone.

Glycine itself has a neutralisation value (NF) of 57, which means that less acid is required for neutralisation of a given carbon dioxide carrier, than in the case of a raising acid with a lower neutralisation value.

Glycine presents a low ROR (rate of reaction) of 11, that is to say in accordance with the above-indicated definition (at 21° C.) only 11% of the theoretically available amount of carbon dioxide is delivered from the carbon dioxide carrier in the first 8 minutes of the beating-up process. Glycine is thus a greatly delayed raising acid. The residual carbon dioxide is only later liberated as a so-called ‘oven leavening agent’ at elevated temperature in the baking process.

In a preferred embodiment of the invention the raising acid combination in the leavening system according to the invention includes glycine in combination with fumaric acid as at least one further raising acid. With that raising acid combination, the results achieved are a bakery-typical taste, an open pore structure and a larger volume than with fumaric acid alone. Fumaric acid is a raising acid which can be obtained inexpensively with a particularly high NV of about 145 and an ROR of 57. The leavening efficiency of the fumaric acid is improved once again by the combination with glycine. In addition the combination of glycine and fumaric acid is phosphate-free so that the troublesome pyrophosphate taste such as for example when using SAPP also does not occur.

A further preferred embodiment of the invention includes the raising acid combination of fumaric acid, citric acid and glycine. That raising acid combination has the advantage that it develops a leavening action comparable to SAPP, but the taste remains bakery-typical and no phosphate taste occurs. Furthermore that combination can be inexpensively produced by inexpensive citric acid.

In a further embodiment of the leavening system according to the invention the leavening system further includes at least one carbon dioxide carrier, preferably sodium hydrogen phosphate which reacts with the raising acids, liberating carbon dioxide.

The invention also includes the use of the leavening system according to the invention described herein as a baking leavening agent for the production of fine bakery products, baking powder, baking mixtures or ready-to-use flours. Even if the invention is described herein predominantly in connection with the production of bakery products and has particular advantages in that respect, the invention also includes the advantageous use of the leavening system according to the invention as a constituent of foaming agents for the production of foamed plastic materials. In that case, besides the excellent leavening efficiency, it has the particular advantage that the leavening agent is harmless to health and completely biologically degradable.

The invention also further includes the use of the raising acid combination according to the invention described herein for the production of a leavening system, preferably a baking leavening agent.

The invention is further described by the examples hereinafter without being limited thereto.

### EXAMPLES

### Dough Production

The doughs were produced in accordance with the following composition for carrying out comparative tests in accordance with the examples hereinafter.

Dough composition

| Constituents | [g] |
|---|---|
| Sugar, fine | 270 |
| Wheat flour type 550 | 200 |
| Whole egg | 150 |
| Baking margarine | 120 |
| Wheat starch | 100 |
| Water | 100 |
| Beating-up emulsifier (*) | 15 |
| NaHCO₃ | 2.5 |
| NaCl | 2 |
| Raising acid or raising acid combination | (**) |

(*) Spongolit 283 from Cognis was used as the beating-up emulsifier: it comprises 35% emulsifiers (mono- and diglycerides of edible fatty acids, esterified with lactic acid, and polyglycerine ester of edible fatty acids (E475), and 65% carrier glucose syrup, skimmed milk powder and stabiliser (E450) as technical additive.
The raising acid or raising acid combination, unless otherwise stated, was used in an amount which in accordance with its neutralisation value (theoretical) leads to complete neutralisation of the carbon dioxide carrier used, sodium hydrogen carbonate.
(**) The following applies for pure raising acids:
$gram of acid carrier = \frac{gram carbon dioxide carrier \times 100}{NV}$ The following applies for raising acid combinations:
$gram of acid carrier in total = \frac{gram carbon dioxide carrier \times 100}{\%1 \times NV 1 + \%2 \times NV 2 + \%3 \times NV 3}$ %1, %2, %3 . . . = percent by weight of acid carrier 1, 2, 3 . . . in the raising acid combination
NV1, NV2, NV3 . . . = neutralisation value of acid carrier 1, 2, 3 . . . in the raising acid combination.

SAPP alone with an NV of 73 was thus used in an amount of 3.4 grams and glycine alone with an NV of 53 was used in an amount of 4.7 grams. A raising acid combination comprising 50% by weight of glycine and 50% by weight of SAPP was accordingly used in an amount of 3.97 grams.

### Dough Production in the All-in Method

The whole egg used was homogenised prior to use in the dough in an Ultra-Turrax (Janke & Kunkel) and just like the water set to ambient temperature. The dry ingredients were weighed out together into a pan and well stirred with an eggbeater. The margarine was weighed in separately, added to the mixed dry ingredients and roughly broken up with a propeller stirrer. The ingredients were then transferred into the stirring pan of a stirring machine (Hobart) and initially stirred at lowest stage 1. After 15 seconds the weighed-out homogenised whole egg and the measured amount of water were added. After a further 20 seconds stirring was then effected at the next higher stage 2 for 1 minute and thereafter at the next higher stage 3 for a further 3 minutes. The stirring machine was then switched off.

Portions of the dough mixture, each weighing 400 g, were weighed out into moulds and baked for 45 minutes in an oven at 200° C. lower heating and 220° C. upper heating.

### Example 1

In this example pure glycine (100%), other pure raising acids and raising acid combinations comprising 50% glycine and 50% of a respective other raising acid were compared. The parameters investigated were the leavening efficiency, measured as a specific bakery volume, the taste of the bakery product and the number of pores.

### Results:

| | Specific bakery | | |
|---|---|---|---|
| Raising acid/raising | product volume | | Number |
| acid combination | [ml/g] | Taste | of pores |
| 100% glycine | 2.71 | adversely affected, | 3217 |
| | | burnt | |
| 100% SAPP 28 | 2.66 | pyrophosphate taste | 3061 |
| (comparative Ex.) | | | |
| 50% SAPP 28 | 2.78 | almost bakery-typical | 3367 |
| 50% glycine | | | |
| 100% GDL | 2.69 | rather insipid | 3315 |
| (comparative Ex.) | | | |
| 50% GDL | 2.79 | bakery-typical | 3292 |
| 50% glycine | | | |
| 100% lactic acid | 2.32 | rather sour and floury | 3125 |
| (comparative Ex.) | | | |
| 50% lactic acid | 2.65 | bakery-typical, | 3108 |
| 50% glycine | | rounded off | |
| 100% citric acid | 2.31 | rather sour | 3066 |
| (comparative Ex.) | | | |
| 50% citric acid | 2.58 | bakery-typical | 3062 |
| 50% glycine | | | |
| 100% tartaric acid | 2.34 | bakery-typical | 3055 |
| (comparative Ex.) | | | |
| 50% tartaric acid | 2.57 | bakery-typical | 3096 |
| 50% glycine | | | |
| 100% fumaric acid | 2.63 | bakery-typical, rather | 3303 |
| (comparative Ex.) | | sour | |
| 50% fumaric acid | 2.72 | bakery-typical | 3235 |
| 50% glycine | | | |
| 100% L-aspartic acid | 2.69 | bakery-typical, rather | 3240 |
| (comparative Ex.) | | sweet | |
| 50% L-aspartic acid | 2.72 | bakery-typical, less | 3111 |
| 50% glycine | | sweet | |

Summary: With pure glycine (100%) as the raising acid a volume improvement was achieved in comparison with the other pure raising acids. With the raising acid combination of glycine and a respective further raising acid in a ratio of 1:1, a respective volume improvement was achieved in relation to pure further raising acid (not glycine) and in most cases there was an improvement in taste. The generally positive effect on the development of volume had not been something that would be expected. In some cases the specific volume of the combination is even above the values of both individual components, as is to be observed in the case of SAPP and GDL (glucono-delta-lactone) with glycine.

In comparison with the other pure raising acids glycine has a very low ROR of 10 to 11. When using pure glycine (100%) or a high proportion of glycine therefore only little carbon dioxide is developed at the beginning of dough preparation. That slight leavening effect leads to a high specific bakery volume which is higher than when using SAPP. A disadvantage of pure glycine as raising acid however is the adversely affected taste and a very dark surface for the bakery product, which however may be acceptable with certain kinds of bakery products and which can be offset by the advantage of the particularly high raising efficiency. In the combination with SAPP the specific bakery product volume is increased in comparison with both individual components. A synergy in respect of the individual components is therefore observed in terms of loosening, which was not to be expected. The differing taste is markedly reduced in the combination, in comparison with the adversely affected taste of pure glycine.

In the combination with GDL (glucono-delta-lactone) glycine once again increases the basic bakery product volume in comparison with both individual components. In this case also therefore a synergy is observed in respect of the individual components in the loosening effect, which was not to be expected. The differing taste is markedly reduced in the combination in comparison with the impaired taste of pure glycine and in comparison with the insipid taste of pure GDL, towards a bakery-typical taste.

The raising acid combination of glycine and fumaric acid afforded a satisfactory bakery-typical taste. The impaired taste of pure glycine like also the rather sour taste of pure fumaric acid disappear.

### Example 2

This example involved investigating the effect of glycine as a low-dosage additive to a combination of fumaric acid and citric acid. The parameters investigated were the raising efficiency, measured as specific bakery product volume, and the taste of the bakery product.

Raising acid combination: glycine+fumaric acid+citric acid
Parameters investigated: specific bakery product volume, taste

### Results:

| | Specific bakery | |
|---|---|---|
| Raising acid/raising | product volume | |
| acid combination | [ml/g] | Taste |
| 100% fumaric acid | 2.63 | bakery-typical, |
| (comparative Ex.) | | rather sour |
| 100% citric acid | 2.31 | rather sour |
| (comparative Ex.) | | |
| 75% fumaric acid | 2.45 | bakery-typical |
| 25% citric acid | | |
| (comparative Ex.) | | |
| 65% fumaric acid | 2.65 | bakery-typical |
| 25% citric acid | | |
| 10% glycine | | |

Summary: Glycine as an additional low-dosage component in relation to a mixture of fumaric acid and citric acid can also contribute to improved raising efficiency with at the same time improved or at least not worsened taste.

What is claimed is:

1. A leavening system for the production of bakery products having a raising acid and at least one gas carrier that reacts with the raising acid or acids with the liberation of gas, wherein as raising acid it contains glycine alone (100%) or in combination with at least one further raising acid different from glycine.

2. The leavening system according to claim 1 including at least one further raising acid different from glycine selected from acid sodium pyrophosphate (SAPP), citric acid, fumaric acid, asparagine, tartaric acid, tartar (potassium hydrogen tartrate), glucono-delta lactone, sodium hydrogen citrate, lactic acid and mixtures and combinations of the aforementioned substances.

3. The leavening system according to claim 1 wherein the at least one further raising acid different from glycine is fumaric acid, citric acid or a mixture or combination of fumaric acid and citric acid.

4. The leavening system according to claim 1 wherein the combination of glycine with at least one further raising acid different from glycine contains from 5 to 95% by weight of glycine with the balance being raising acid or acids different from glycine.

5. The leavening system according to claim 1 wherein the combination of glycine with at least one further raising acid different from glycine contains from 10 to 90% by weight of glycine with the balance being raising acid or acids different from glycine.

6. The leavening system according to claim 1 wherein the combination of glycine with at least one further raising acid different from glycine contains from 20 to 80% by weight of glycine with the balance being raising acid or acids different from glycine.

7. The leavening system according to claim 1 wherein the combination of glycine with at least one further raising acid different from glycine contains from 30 to 70% by weight of glycine with the balance being raising acid or acids different from glycine.

8. The leavening system according to claim 1 wherein, as the gas carrier, the leavening system contains at least one carbon dioxide carrier that reacts with the raising acid or acids with the liberation of carbon dioxide.

9. The leavening system according to claim 1 wherein the leavening system further contains sodium hydrogen carbonate as a carbon dioxide carrier that reacts with the raising acid or acids with the liberation of carbon dioxide.

10. The leavening system according to claim 2 wherein the leavening system further contains sodium hydrogen carbonate as a carbon dioxide carrier that reacts with the raising acid or acids with the liberation of carbon dioxide.

11. A method for the production of fine bakery products, ready-to-use flours, baking powder or baking mixtures wherein the leavening system as is defined in claim 1 is used as a bakery leavening agent.

12. A method for the production of a leavening system, comprising including a raising acid containing glycine alone (100%) or in combination with at least one further raising acid different from glycine.
